(19) United States
(12) Patent Application Publication
(10) Pub. No.: US 2025/0322308 A1
(43) Pub. Date: Oct. 16, 2025

(54) INFORMATION PROCESSING APPARATUS, INFORMATION PROCESSING METHOD, AND RECORDING MEDIUM

(71) Applicant: NEC Corporation, Tokyo (JP)

(72) Inventors: Genki KUSANO, Tokyo (JP); Yuyang DONG, Tokyo (JP)

(73) Assignee: NEC Corporation, Tokyo (JP)

(21) Appl. No.: 19/170,175

(22) Filed: Apr. 4, 2025

(30) Foreign Application Priority Data
Apr. 12, 2024 (JP) 2024-064946

(51) Int. Cl. G06N 20/00

(52) U.S. Cl. CPC G06N 20/00

(57) ABSTRACT

Provided is a recommendation technique for making it possible to cope with the cold start problem while limiting an increase in cost. This information processing apparatus includes a first acquiring section for acquiring information regarding a user; a second acquiring section for acquiring information regarding an item; one or more transforming sections for performing a transformation to a vector on each of the information regarding the user and the information regarding the item, the one or more transforming sections being trained with use of training data which includes data generated by a trained model; and a predicting section for predicting compatibility between the user and the item with reference to the vector obtained through the transformation performed by the at least one transforming section.

### CROSS REFERENCE TO RELATED APPLICATIONS

This application is based upon and claims the benefit of priority from Japanese Patent Application No. 2024-064946 filed on Apr. 12, 2024, the disclosure of which is incorporated herein in its entirety by reference.

### TECHNICAL FIELD

The present invention relates to an information processing apparatus, an information processing method, and a recording medium.

### BACKGROUND ART

Recommendation systems for recommending an item (product, measure, etc.) to a certain user and for identifying a user who matches a certain item have been known. For example, Non-Patent Literature 1 discloses a technique for recommending a new user and a new item through randomized training.

### CITATION LIST

### Non-Patent Literature

### [Non-patent Literature 1]

“Recommendation for New Users and New Items via Randomized Training and Mixture-of-Experts Transformation”, Ziwei Zhu et al, SIGIR '20, Jul. 25-30, 2020, Virtual Event, China

### SUMMARY OF INVENTION

### Technical Problem

Typically, with recommendation systems, there is a problem (also referred to as cold start problem) of what recommendation should be made to a new user or a new system between which no correlation history (e.g., a rating history) is present. In Non-Patent Literature 1, coping with the cold start problem by carrying out training in which an auxiliary representation is included is proposed.

However, with the technique disclosed in Non-Patent Literature 1, it is necessary to prepare a sufficient amount of training data which includes an auxiliary representation. This presents a problem of an increase in cost for the preparation.

The present disclosure has been made in view of the above problem, and an example object thereof is to provide a recommendation technique which makes it possible to cope with the cold start problem while limiting an increase in cost.

### Solution to Problem

An information processing apparatus in accordance with an example aspect of the present disclosure includes at least one processor, and the at least one processor carries out: a first acquiring process of acquiring information regarding a user; a second acquiring process of acquiring information regarding an item; a transforming process that is carried out with use of one or more transforming means for performing a transformation to a vector on each of the information regarding the user and the information regarding the item, the one or more transforming means being trained with use of training data which includes data generated by a trained model; and a predicting process of predicting compatibility between the user and the item with reference to the vector obtained through the transformation performed by the transforming process.

An information processing apparatus in accordance with an example aspect of the present disclosure includes at least one processor, and the at least one processor carries out: a first acquiring process of acquiring at least one piece of information selected from the group consisting of information regarding a user and information regarding an item; a second acquiring process of acquiring, with reference to the at least one piece of information acquired by the first acquiring process, data generated by a trained model; and a training process of training one or more transforming means use of training data which includes the data acquired by the second acquiring process, the one or more transforming means being configured to perform a transformation to a vector on each of the user and the item.

An information processing method in accordance with an example aspect of the present disclosure includes: at least one processor acquiring information regarding a user; the at least one processor acquiring information regarding an item; the at least one processor performing a transformation to a vector on each of the information regarding the user and the information regarding the item via one or more transforming means, the one or more transforming means being trained with use of training data which includes data generated by a trained model; and the at least one processor predicting compatibility between the user and the item with reference to the vector obtained through the transformation.

A non-transitory recording medium in accordance with an example aspect of the present disclosure stores a program for causing a computer to function as an information processing apparatus, and the program causes the computer to carry out: a first acquiring process of acquiring information regarding a user; a second acquiring process of acquiring information regarding an item; a transforming process that is carried out with use of one or more transforming means for performing a transformation to a vector on each of the information regarding the user and the information regarding the item, the one or more transforming means being trained with use of training data which includes data generated by a trained model; and a predicting process of predicting compatibility between the user and the item with reference to the vector obtained through the transformation performed by the transforming process.

A non-transitory recording medium in accordance with an example aspect of the present disclosure stores a program for causing a computer to function as an information processing apparatus, and the program causes the computer to carry out: a first acquiring process of acquiring at least one piece of information selected from the group consisting of information regarding a user and information regarding an item; a second acquiring process of acquiring, with reference to the at least one piece of information acquired by the first acquiring process, data generated by a trained model; and a training process of training one or more transforming means with use of training data which includes the data acquired by the second acquiring process, the one or more transforming means being configured to perform a transformation to a vector on each of the user and the item.

### Advantageous Effects of Invention

With the present disclosure, it is possible to provide a recommendation technique which makes it possible to cope with the cold start problem while limiting an increase in cost.

### BRIEF DESCRIPTION OF DRAWINGS

FIG. 1 is a block diagram illustrating a configuration of an information processing apparatus in accordance with the present disclosure.

FIG. 2 is a flowchart illustrating a flow of an information processing method in accordance with the present disclosure.

FIG. 3 is a block diagram illustrating a configuration of an information processing apparatus in accordance with the present disclosure.

FIG. 4 is a flowchart illustrating a flow of an information processing method in accordance with the present disclosure.

FIG. 5 is a block diagram illustrating a configuration of an information processing system in accordance with the present disclosure.

FIG. 6 is a diagram for explaining information processing in accordance with the present disclosure.

FIG. 7 is a diagram for explaining information processing in accordance with the present disclosure.

FIG. 8 is a diagram for explaining information processing in accordance with the present disclosure.

FIG. 9 is a diagram for explaining information processing in accordance with the present disclosure.

FIG. 10 is a diagram for explaining information processing in accordance with the present disclosure.

FIG. 11 is a diagram for explaining information processing in accordance with the present disclosure.

FIG. 12 is a diagram for explaining information processing in accordance with the present disclosure.

FIG. 13 is a block diagram illustrating a configuration of an information processing apparatus in accordance with the present disclosure.

FIG. 14 is a block diagram illustrating a hardware configuration of the information processing apparatus in accordance with the present disclosure.

### EXAMPLE EMBODIMENTS

The following description will discuss example embodiments of the present invention. However, the present invention is not limited to the example embodiments described below, but can be altered by a skilled person in the art within the scope of the claims. For example, any embodiment derived by appropriately combining techniques (some or all of products or methods) adopted in differing example embodiments described below can be within the scope of the present invention. Further, any embodiment derived by appropriately omitting one or more of the techniques adopted in differing example embodiments described below can be within the scope of the present invention. Furthermore, the advantage mentioned in each of the example embodiments described below is an example advantage expected in that example embodiment, and does not define the extension of the present invention. That is, any embodiment which does not provide any of the example advantages mentioned in the example embodiments described below can also be within the scope of the present invention.

### First Example Embodiment

The following description will discuss a first example embodiment, which is an example embodiment of the present invention, in detail with reference to the drawings. The present example embodiment is basic to each of the example embodiments which will be described later. It should be noted that the applicability of the techniques adopted in the present example embodiment is not limited to the present example embodiment. That is, the techniques adopted in the present example embodiment can be adopted in another example embodiment included in the present disclosure, to the extent of constituting no specific technical obstacle. Further, the techniques illustrated in the drawings referred to for the description of the present example embodiment can be adopted in another example embodiment included in the present disclosure, to the extent of constituting no specific technical obstacle.

### (Configuration of Information Processing Apparatus 1)

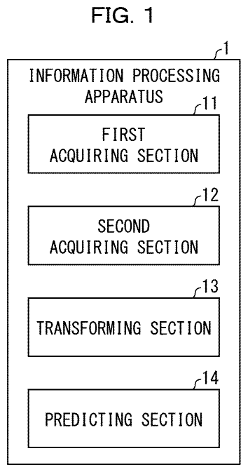

A configuration of an information processing apparatus 1 in accordance with the present example embodiment will be described below with reference to FIG. 1. FIG. 1 is a block diagram illustrating the configuration of the information processing apparatus 1. The information processing apparatus 1 includes a first acquiring section 11, a second acquiring section 12, a transforming section 13, and a predicting section 14, as illustrated in FIG. 1.

### (First Acquiring Section 11)

The first acquiring section 11 acquires information regarding a user. As an example, the information regarding a user can include a user ID and a user attribute information associated with the user ID. As an example, the user attribute information can include the gender and the age of the user, and text or the like which expresses the user. For example, the user attribute information can include:
written self-introduction of the user and a statement in business, e.g., a statement “this person likes XX”;
a statement describing interests to express the user, e.g., a statement “this person is interested in golf, wine, and parenting”; and
a statement regarding a product the user has purchased, an advertisement the user has viewed, or a store the user has used (a statement regarding the action history of the user), e.g., a statement “the products this person purchased are a chocolate snack, coffee, and hot wine” or “products this person purchases are characterized by a high class, a luxury, and Europe”.

The format of the user attribute information is not limited to any particular format, and may be a format which is applicable to a predetermined form, or may be changed as appropriate with use of, for example, an attribute which is included in the attribute information. For example, data which is structured such that

| User ID | item |
|---|---|
| 001 | chocolate snack |
| 002 | coffee |
| 003 | hot wine, |

and data which is structured such that

| item | attribute |
|---|---|
| chocolate snack | sweet, high class |
| coffee | luxury, high class |
| hot wine | luxury, Europe |

may be associated with each other in a relational database, so that the user attribute information is structured.

However, the above example does not limit the present example embodiment. For example, the user attribute information may be structured to include an image which expresses the user (the image of the user themselves, the image of an item the user likes, etc.), instead of or together with the text or the like described above.

As partially described above, the user attribute information may include the history of correlation between the user and one or more items. The history of correlation may include information regarding:
whether the user has purchased (used) the items (purchase history, usage history); and
the ratings assigned by the user to the items (rating history).

### (Second Acquiring Section 12)

The second acquiring section 12 acquires information regarding an item. As an example, the “item” includes at least one selected from the group consisting of a product and a measure. The “measure” includes, for example, the date and time of the measure, the name of the measure, and a service or a product to be provided. As an example, the information regarding an item can include an item ID and item attribute information associated with the item ID. As an example, the item attribute information includes text or the like which expresses the details of the item. For example, the item attribute information can include:
a statement explaining the item (measure), e.g., a statement “a campaign for introducing XX, which is popular in YY”; and
a statement explaining the item (product), e.g., a statement “wine and cheese directly imported from Germany”. However, the above example does not limit the present example embodiment. For example, the item attribute information may be structured to include an image which expresses the item (the image of the product, the image of the venue for the campaign, etc.), instead of or together with the text or the like described above.

The item attribute information may include the history of correlation between the item and one or more users. The history of correlation may include information regarding:
whether the item has been purchased (used) by the users (purchase history, usage history); and
the ratings assigned by the users to the item (rating history).

### (Transforming Section 13)

The transforming section 13 performs a transformation to a vector on each of:
the information regarding the user, which is acquired by the first acquiring section 11; and
the information regarding the item, which is acquired by the second acquiring section 12. The transforming section 13 here has been trained with use of training data which includes data generated by a trained model LM. Further, the transforming section 13 may be formed by individual transforming sections, which each perform a transformation to a vector on a corresponding one of the information regarding the user and the information regarding the item. For example, the transforming section 13 may be formed by a first transforming section for performing a transformation to a vector (also referred to as a user vector) on the information regarding the user and a second transforming section for performing a transformation to a vector (also referred to as an item vector) of the information regarding the item.

As an example, the transforming section 13 may be configured to
generate the user vector by inputting the information regarding the user to an embedding model (embedding function) f trained with use of training data which includes data generated by the trained model LM, and
generate the item vector by inputting the information regarding the item to an embedding model (embedding function) f′ trained with use of the training data which includes data generated by the trained model LM.
   The embedding model f′ may be different from the embedding model f, or may be the same as the embedding model f. Further, the transforming section 13 may be trained by contrastive learning.
   Further, as an example and without limiting the present example embodiment, a specific example of the trained model LM may be a language model trained so as to be capable of generating text, or may be a generative model trained so as to be capable of generating an image.

### (Predicting Section 14)

The predicting section 14 predicts compatibility between the user and the item with reference to the vector obtained through the transformation performed by the transforming section 13. As an example, the predicting section 14 may be configured to
derive a similarity between the user vector and the item vector that are generated by the transforming section 13, and
predict compatibility between the user and the item with reference to the similarity derived. As an example, the result of prediction performed by the predicting section 14 is visually presented to the user via a display section (not illustrated) and/or is provided to another apparatus via a communicating section (not illustrated).

### (Example Advantage of Information Processing Apparatus 1)

As above, in the information processing apparatus 1,
information regarding a user and information regarding an item are acquired,
each of the information regarding the user and the information regarding the item is transformed to a vector with use of one or more transforming means (transforming sections 13) trained with use of training data which includes data generated by the trained model LM, and
compatibility between the user and the item is predicted with reference to the vector obtained through the transformation performed by the transforming means.

As above, in the information processing apparatus 1,
each of the information regarding the user and the information regarding the item is transformed to a vector. With this configuration, it is possible to provide a recommendation technique which makes it possible to transform even a new user and/or a new item to a vector and thereby makes it possible to cope with the cold start problem. Further, in the information processing apparatus 1,
the transforming means (transforming section 13) for performing a transformation to a vector is trained with use of training data which includes data generated by the trained model LM, and
compatibility between the user and the item is predicted with reference to the vector obtained through the transformation performed by the transforming means (transforming section 13).
   With this configuration, while it is possible to use the data generated by the trained model LM to suitably train the transforming means (transforming section 13), the trained model LM does not need to be used in an inference phase. Thus, with this configuration, a recommendation technique in which an increase in cost is limited is provided.

### (Flow of Information Processing Method S1)

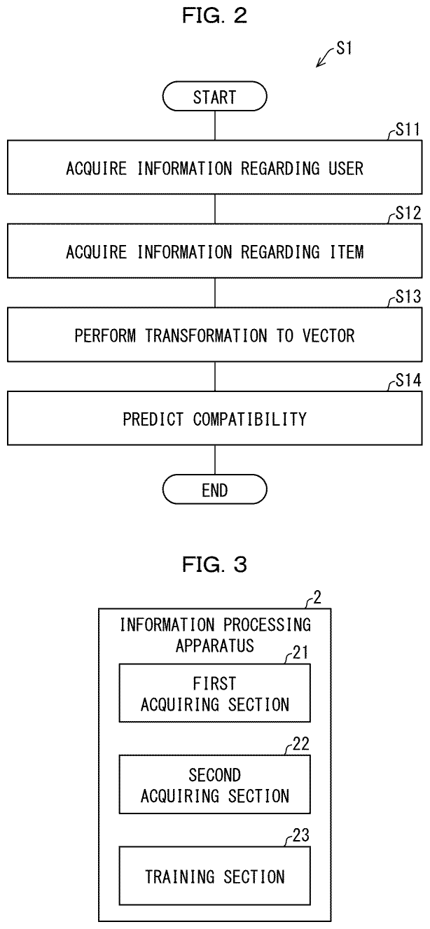

Next, the flow of an information processing method S1 in accordance with the present example embodiment is described here with reference to FIG. 2. FIG. 2 is a flowchart illustrating the flow of the information processing method S1. The information processing method S1 includes a step (process) S11 of acquiring information regarding a user, a step (process) S12 of acquiring information regarding an item, a step (process) S13 of performing a transformation to a vector, and a step (process) S14 of predicting compatibility, as illustrated in FIG. 2.

### (Step S11)

In step S11, the first acquiring section 11 acquires information regarding a user. The first acquiring section 11 is more specifically described above, and the description thereof is therefore omitted here.

### (Step S12)

In step S12, the second acquiring section 12 acquires information regarding an item. The second acquiring section 12 is more specifically described above, and the description thereof is therefore omitted here.

### (Step S13)

Subsequently, in step S13, the transforming section 13 performs a transformation to a vector on each of:
the information regarding the user, which is acquired by the first acquiring section 11; and
the information regarding the item, which is acquired by the second acquiring section 12. The transforming section 13 here has been trained with use of training data which includes data generated by the trained model LM. The transforming section 13 is more specifically described above, and the description thereof is therefore omitted here.

### (Step S14)

Subsequently, in step S14, the predicting section 14 predicts compatibility between the user and the item with reference to the vector obtained through the transformation performed by the transforming section 13. The predicting section 14 is more specifically described above, and the description thereof is therefore omitted here.

### (Example Advantage of Information Processing Method S1)

As above, in the information processing method S1,
information regarding a user and information regarding an item are acquired,
each of the information regarding the user and the information regarding the item is transformed to a vector with use of one or more transforming means (transforming sections 13) trained with use of training data which includes data generated by the trained model LM, and
compatibility between the user and the item is predicted with reference to the vector obtained through the transformation performed by the transforming means. This configuration provides an example advantage similar to that provided by the information processing apparatus 1.

### (Configuration of Information Processing Apparatus 2)

Next, the configuration of an information processing apparatus 2 in accordance with the present example embodiment is described here with reference to FIG. 3. FIG. 3 is a block diagram illustrating the configuration of the information processing apparatus 2. The information processing apparatus 2 includes a first acquiring section 21, a second acquiring section 22, and a training section 23, as illustrated in FIG. 3.

### (First Acquiring Section 21)

The first acquiring section 21 acquires at least one piece of information selected from the group consisting of information regarding a user and information regarding an item. As an example, the information regarding a user can include user attribute information associated with the user. Further, the information regarding a user may include a user ID of the user. As an example, the user attribute information may include at least one of the gender and the age of the user and text or the like which expresses the user. For example, the user attribute information can include:
written self-introduction of the user and a statement in business, e.g., a statement “this person likes XX”;
a statement describing interests to express the user, e.g., a statement “this person is interested in golf, wine, and parenting”; and
a statement regarding a product the user has purchased, an advertisement the user has viewed, or a store the user has used (a statement regarding the action history of the user), e.g., a statement “the products this person purchased are a chocolate snack, coffee, and hot wine” or “products this person purchases are characterized by a high class, a luxury, and Europe”.

The format of the user attribute information is not limited to any particular format, and may be a format which is applicable to a predetermined form, or may be changed as appropriate with use of, for example, an attribute which is included in the attribute information. For example, data which is structured such that

| User ID | item |
|---|---|
| 001 | chocolate snack |
| 002 | coffee |
| 003 | hot wine, |

and data which is structured such that

| item | attribute |
|---|---|
| chocolate snack | sweet, high class |
| coffee | luxury, high class |
| hot wine | luxury, Europe |

may be associated with each other in a relational database, so that the user attribute information is structured.

However, the above example does not limit the present example embodiment. For example, the user attribute information may be structured to include an image which expresses the user (the image of the user themselves, the image of an item the user likes, etc.), instead of or together with the text or the like described above.

As partially described above, the user attribute information may include the history of correlation between the user and one or more items. The history of correlation may include information regarding:
whether the user has purchased d (used) the items (purchase history, usage history); and
the ratings assigned by the user to the items (rating history).

As an example, the information regarding an item can include item attribute information associated with the item. Further, the information regarding an item may include an item ID of the item. As an example, the item attribute information includes text or the like which expresses the details of the item. For example, the item attribute information can include:
a statement explaining the item (measure), e.g., a statement “a campaign for introducing XX, which is popular in YY”; and
a statement explaining the item (product), e.g., a statement “wine and cheese directly imported from Germany”. However, the above example does not limit the present example embodiment. For example, the item attribute information may be structured to include an image which expresses the item (the image of the product, the image of the venue for the campaign, etc.), instead of or together with the text or the like described above.

The item attribute information may include the history of correlation between the item and one or more users. The history of correlation may include information regarding:
whether the item has been purchased (used) by the users (purchase history, usage history); and
the ratings assigned by the users to the item (rating history).

### (Second Acquiring Section 22)

The second acquiring section 22 acquires data generated by the trained model LM, with reference to the information (at least one piece of information selected from the group consisting of the information regarding the user and the information regarding the item) acquired by the first acquiring section 21. As an example, the second acquiring section 22 may carry out the process of
generating one or more prompts with reference to the information acquired by the first acquiring section 21, and
acquiring, as the data generated by the trained model LM, data outputted by the trained model LM which has inputted thereto the one or more prompts generated. As an example, the “prompt” refers to “data having been transformed to text, which is the format of an input to the trained model LM”. However, this wording does not limit the present example embodiment.

As an example and without limiting the present example embodiment, a specific example of the trained model LM may be a language model trained so as to be capable of generating text, or may be a generative model trained so as to be capable of generating an image.

### (Training Section 23)

The training section 23 uses training data which includes the data acquired by the second acquiring means, to train one or more transforming means for performing a transformation to a vector on each of the user and the item. The transforming means may be formed by individual transforming sections, which each perform a transformation to a vector on a corresponding one of the information regarding the user and the information regarding the item. For example, like the transforming section 13 of the information processing apparatus 1, the transforming means may be formed by a first transforming section for performing a transformation to a vector (also referred to as a user vector) on the information regarding the user and a second transforming section for performing a transformation to a vector (also referred to as an item vector) on the information regarding the item.

As an example, the transforming means may be configured to
generate the user vector by inputting the information regarding the user to an embedding model (embedding function) f trained with use of training data which includes data generated by the trained model LM, and
generate the item vector by inputting the information regarding the item to an embedding model (embedding function) f′ trained with use of the training data which includes data generated by the trained model LM. The embedding model f′ may be different from the embedding model f, or may be the same as the embedding model f.

The training section 23 uses the training data which includes the data acquired by the second acquiring means, to train the transforming means configured as above. As an example, the training section 23 trains the transforming means by contrastive learning. Further, the training section 23 may train the transforming means with reference to:
a first loss value obtained with reference to the data generated by the trained model LM; and
a second loss value obtained with reference to data other than the data generated by the trained model LM such that these loss values decrease.

As an example, the transforming means (or the parameters defining the transforming means) trained by the training section 23 is stored in a storage section (not illustrated) and is used in a transforming process in an inference phase.

### (Example Advantage of Information Processing Apparatus 2)

As above, in the information processing apparatus 2,
at least one piece of information selected from the group consisting of information regarding a user and information regarding an item is acquired,
data generated by a trained model is acquired with reference to the piece of information acquired, and
one or more transforming means for performing a transformation to a vector on each of the user and the item are trained with use of training data which includes the data acquired.

As above, in the information processing apparatus 2,
one or more transforming means for performing a transformation to a vector on each of the user and the item are trained with use of training data which includes the data acquired.

With this configuration, it is possible to provide a recommendation technique which makes it possible to train a transforming means which is capable of transform even a new user and/or a new item to a vector and thereby makes it possible to cope with the cold start problem. Further, while it is possible to use the data generated by the trained model IM to suitably train the transforming means, the trained model LM does not need to be used in an inference phase. Thus, with this configuration, a recommendation technique in which an increase in cost is limited is provided.

### (Flow of Information Processing Method S2)

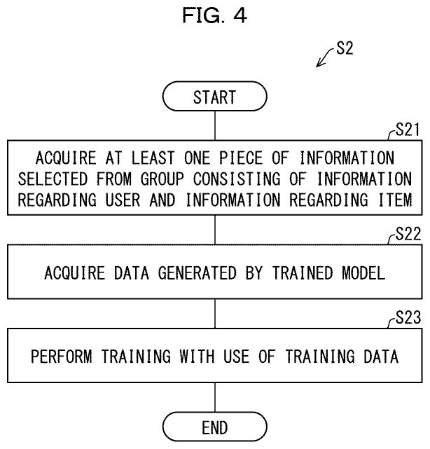

Next, the flow of an information processing method S2 in accordance with the present example embodiment is described here with reference to FIG. 4. FIG. 4 is a flowchart illustrating the flow of the information processing method S2. The information processing method S2 includes a step (process) S21 of acquiring at least one piece of information selected from the group consisting of information regarding a user and information regarding an item, a step (process) S22 of acquiring data generated by a trained model, and step (process) S23 of performing training with use of training data, as illustrated in FIG. 4.

### (Step S21)

In step S21, the first acquiring section acquires at least one piece of information selected from the group consisting of information regarding a user and information regarding an item. The first acquiring section 21 is more specifically described above, and the description thereof is therefore omitted here.

### (Step S22)

Subsequently, in step S22, the second acquiring section 22 acquires data generated by the trained model LM, with reference to the information (at least one piece of information selected from the group consisting of the information regarding the user and the information regarding the item) acquired by the first acquiring section 21 in step S21. The second acquiring section 22 is more specifically described above, and the description thereof is therefore omitted here.

### (Step S23)

Subsequently, in step S23, the training section 23 uses training data which includes the data acquired by the second acquiring means in step S22, to train one or more transforming means for performing a transformation to a vector on each of the user and the item. The training section 23 is more specifically described above, and the description thereof is therefore omitted here.

### (Example Advantage of Information Processing Method S2)

As above, in the information processing method S2,
at least one piece of information selected from the group consisting of information regarding a user and information regarding an item is acquired,
data generated by a trained model is acquired with reference to the piece of information acquired, and
one or more transforming means for performing a transformation to a vector on each of the user and the item are trained with use of training data which includes the data acquired. This configuration provides an example advantage similar to that provided by the information processing apparatus 2.

### Second Example Embodiment

The following description will discuss a second example embodiment, which is an example embodiment of the present invention, in detail with reference to the drawings. A component having the same function as a component described in the above example embodiment is assigned the same reference sign, and the description thereof is omitted where appropriate. It should be noted that the applicability of the techniques adopted in the present example embodiment is not limited to the present example embodiment. That is, the techniques adopted in the present example embodiment can be adopted in another example embodiment included in the present disclosure, to the extent of constituting no specific technical obstacle. Further, the techniques illustrated in the drawings referred to for the description of the present example embodiment can be adopted in another example embodiment included in the present disclosure, to the extent of constituting no specific technical obstacle.

### (Configuration of Information Processing System 1A)

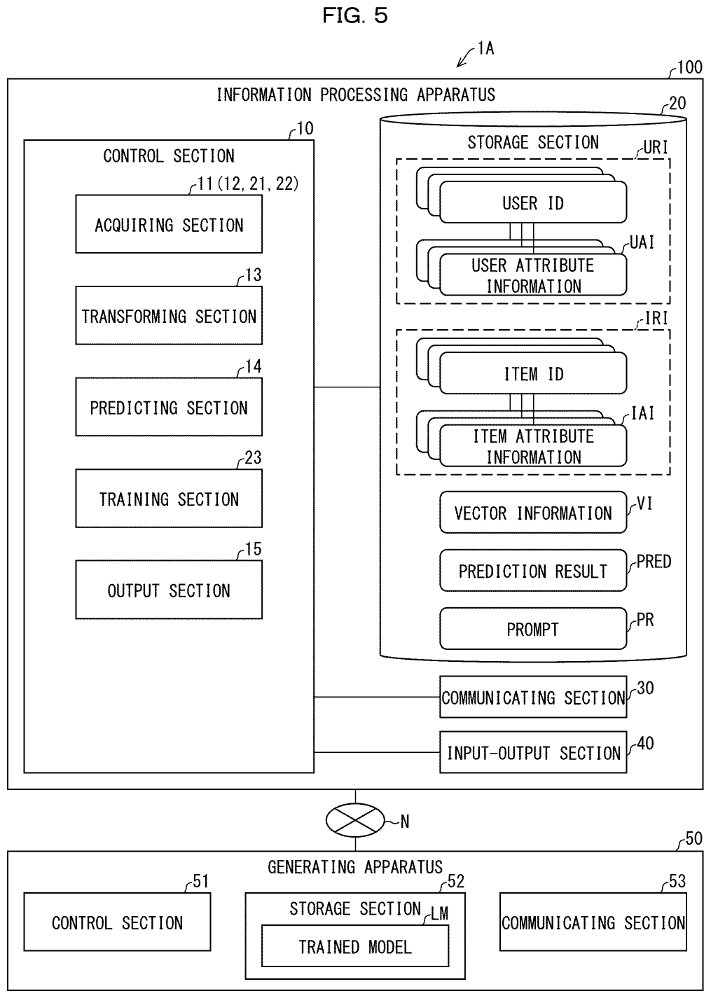

The configuration of an information processing system 1A in accordance with the present example embodiment is described here with reference to FIG. 5. FIG. 5 is a block diagram illustrating the configuration of the information processing system 1A. The information processing system 1A includes an information processing apparatus 100 and a generating apparatus 50, which is connected to the information processing apparatus 100 via a network N, as illustrated in FIG. 5. As an example and without limiting the present example embodiment, a specific configuration of the network N can include a wireless local area network (LAN), a wired LAN, a wide area network (WAN), a public network, a mobile data communication network, and a combination thereof.

### (Generating Apparatus 50)

The generating apparatus 50 includes a control section 51, a storage section 52, and a communicating section 53, as illustrated in FIG. 5. The communicating section 53 communicates with an apparatus external to the generating apparatus 50. As an example, the communicating section 53 communicates with the information processing apparatus 100 of the information processing system 1A. The communicating section 53 transmits data supplied by the control section 51 to the information processing apparatus 100 and supplies the control section 51 with data received from the information processing apparatus 100. The data received by the communicating section 53 from the information processing apparatus 100 can include a prompt generated by the information processing apparatus 100. Further, the data provided by the communicating section 53 to the information processing apparatus 100 can include at least one piece of data selected from the group consisting of text data and image data which are generated by a language model LM (described later) on the basis of the prompt.

The storage section 52 has stored therein the language model LM. As an example, the storage section 52 has stored therein a plurality of parameters which define the language model LM. As an example and without limiting the present example embodiment, these parameters are parameters trained by machine learning in advance (parameters having undergone an update process by machine learning). Further, as an example, the language model LM is trained with use of a large number of pieces of text and a large number of images. However, example does not limit the present example embodiment.

The control section 51 uses the language model LM to acquire an output result of the language model LM. As an example, the control section 51 inputs, to the language model LM, the prompt received from the information processing apparatus 100, to acquire text data or image data generated by the language model LM. Further, the control section 51 provides the information processing apparatus 100 with the text data or the image data via the communicating section 53.

In the present example embodiment, the generating apparatus 50 is separate from the information processing apparatus 100, by way of example and without limiting the present example embodiment. A control section of the information processing apparatus 100 may have the functions of the control section 51 of the generating apparatus 50 or the control section 51 that serves as a language model executing section. Similarly, the language model LM stored in the storage section 52 of the generating apparatus 50 may be stored in a storage section of the information processing apparatus 100 so that the information processing apparatus 100 itself can execute the language model LM.

### (Configuration of Information Processing Apparatus 100)

Next, the configuration of the information processing apparatus 100 in accordance with the present example embodiment is described here with reference to FIG. 5. The information processing apparatus 100 includes a control section 10, a storage section 20, a communicating section 30, and an input-output section 40, as illustrated in FIG. 5.

### (Communicating Section 30)

The communicating section 30 communicates with an apparatus external to the information processing apparatus 100. As an example, the communicating section 30 communicates with the generating apparatus 50. The communicating section 53 transmits data supplied by the control section 10 to the generating apparatus 50 and supplies the control section 10 with data received from the generating apparatus 50. The data transmitted by the communicating section 30 to the generating apparatus 50 can include a prompt generated by the control section 10. Further, the data received by the communicating section 30 from the generating apparatus 50 can include at least one piece of data selected from the group consisting of text data and image data which are generated by the generating apparatus 50 on the basis of the prompt.

### (Input-Output Section 40)

The input-output section 40 has such a configuration as to include at least one of pieces of input-output equipment such as a keyboard, a mouse, a display, a printer, and a touch panel. Alternatively, the input-output section 40 may be configured such that input/output equipment such as a keyboard, a mouse, a display, a printer, or a touch panel is connected thereto. In a case of this configuration, the input-output section 40 accepts inputs of various kinds of information to the information processing apparatus 100, via the input equipment connected thereto. Further, the input-output section 40 outputs various kinds of information to output equipment connected thereto, under the control of the control section 10. Examples of the input-output section 40 include an interface such as a universal serial bus (USB).

### (Storage Section 20)

The storage section 20 has stored therein various kinds of data referred to by the control section 10 and various kinds of data generated by the control section 10. As an example, the storage section 20 has stored therein:
user-related information URI;
item-related information IRI;
vector information VI;
prediction result PRED;
prompt PR; etc.

The user-related information URI is information regarding each of one or more users. As an example, the user-related information URI can include a user ID related to each user and user attribute information associated with the user ID. As an example, the user attribute information can include the gender and the age of the user, and text or the like which expresses the user. A specific example of the user-related information URI will be described later, and the description thereof is therefore omitted here.

The item-related information IRI is information regarding each of one or more items. As an example, the “items” include at least one selected from the group consisting of a product and a measure. The “measure” includes, for example, the date and time of the measure, the name of the measure, and a service or a product to be provided. As an example, the information regarding each item can include an item ID and item attribute information associated with the item ID. As an example, the item attribute information includes text or the like which expresses the details of the item. A specific example of the item-related information IRI will be described later, and the description thereof is therefore omitted here.

The vector information VI is information regarding a vector generated by the transforming section 13 (described later). As an example, the vector information VI includes values of the respective components which define the vector generated by the transforming section 13. A specific example of the vector information VI will be described later, and the description thereof is therefore omitted here.

The prediction result PRED is information indicating a prediction result derived by the predicting section 14 (described later). A specific example of the prediction result PRED will be described later, and the description thereof is therefore omitted here.

The prompt PR is generated by the training section 23 (described later) and is provided to the trained model LM. A specific example of the prompt PR will be described later, and the description thereof is therefore omitted here.

### (Control Section 10)

The control section 10 includes an acquiring section 11, a transforming section 13, a predicting section 14, a training section 23, and an output section 15, as illustrated in FIG. 5. The acquiring section 11 has functions similar to the functions of the first acquiring section 11 and the second acquiring section 12 of the information processing apparatus 1 described in the first example embodiment and the functions of the first acquiring section 21 and the second acquiring section 22 of the information processing apparatus 2 described in the first example embodiment. Thus, the acquiring section 11 can be denoted by the acquiring section 11 (12, 21, 22).

### (Acquiring Section 12)

The acquiring section 12 acquires information regarding a user and information regarding an item. As described in the first example embodiment, as an example, the information regarding a user can include user attribute information associated with the user. Further, the information regarding a user may include a user ID of the user. As an example, the user attribute information may include at least one of the gender and the age of the user and text or the like which expresses the user. For example, the user attribute information can include:
written self-introduction of the user and a statement in business, e.g., a statement “this person likes XX”;
a statement describing interests to express the user, e.g., a statement “this person is interested in golf, wine, and parenting”; and
a statement regarding a product the user has purchased, an advertisement the user has viewed, or a store the user has used (a statement regarding the action history of the user), e.g., a statement “the products this person purchased are a chocolate snack, coffee, and hot wine” or “products this person purchases are characterized by a high class, a luxury, and Europe”.

The format of the user attribute information is not limited to any particular format, and may be a format which is applicable to a predetermined form, or may be changed as appropriate with use of, for example, an attribute which is included in the attribute information. For example, data which is structured such that

| User ID | item |
|---|---|
| 001 | chocolate snack |
| 002 | coffee |
| 003 | hot wine, |

and data which is structured such that

| item | attribute |
|---|---|
| chocolate snack | sweet, high class |
| coffee | luxury, high class |
| hot wine | luxury, Europe |

may be associated with each other in a relational database, so that the user attribute information is structured.

However, the above example does not limit the present example embodiment. For example, the user attribute information may be structured to include an image which expresses the user (the image of the user themselves, the image of an item the user likes, etc.), instead of or together with the text or the like described above.

As partially described above, the user attribute information may include the history of correlation between the user and one or more items. The history of correlation may include information regarding:
whether the user has purchased (used) the items (purchase history, usage history); and
the ratings assigned by the user to the items (rating history).

As described in the first example embodiment, as an example, the information regarding an item can include item attribute information associated with the item. Further, the information regarding an item may include an item ID of the item. As an example, the item attribute information includes text or the like which expresses the details of the item. For example, the item attribute information can include:
a statement explaining the item (measure), e.g., a statement “a campaign for introducing XX, which is popular in YY”; and
a statement explaining the item (product), e.g., a statement “wine and cheese directly imported from Germany”. However, the above example does not limit the present example embodiment. For example, the item attribute information may be structured to include an image which expresses the item (the image of the product, the image of the venue for the campaign, etc.), instead of or together with the text or the like described above.

The item attribute information may include the history of correlation between the item and one or more users. The history of correlation may include information regarding:
whether the item has been purchased (used) by the users (purchase history, usage history); and
the ratings assigned by the users to the item (rating history).

### (Transforming Section 13)

The transforming section 13 performs a transformation to a vector on each of the information regarding the user and the information regarding the item, which are acquired by the acquiring section 11. The transforming section 13 here has been trained with use of training data which includes data generated by the above-described trained model LM.

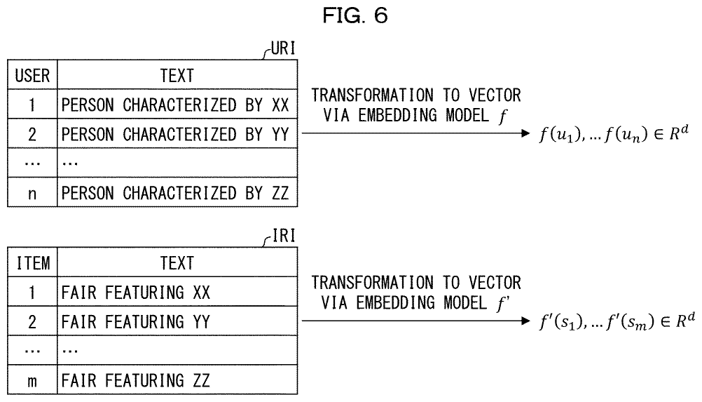

FIG. 6 is a schematic view of processes carried out by the transforming section 13. As illustrated in FIG. 6, as an example, the transforming section 13 carries out the process of
performing a transformation to a user vector on information regarding each of one or more users included in the user-related information URI, with use of an embedding model (embedding function) f, and
performing a transformation to an item vector on information regarding each of one or more items included in the item-related information IRI, with use of an embedding model (embedding function) f′. The embedding models f and f′ here have been trained by the training section 23 (described later) with use of training data which includes data generated by the trained model LM. As a specific example of the embedding models f and f′, a model such as bidirectional encoder representations from transformers (BERT) can be used. However, this example does not limit the present example embodiment.

In the examples illustrated in FIG. 6, user-related information (text) regarding each of the users who is identified by a user ID=i (i=1 to n):
u₁, . . . , uₙ
   is transformed by the embedding model f to corresponding user vector:
f(u₁), . . . , f(uₙ)
   As an example, each user vector f(uᵢ) is a d-dimensional vector.

Similarly, in the example illustrated in FIG. 6, item-related information (text) regarding each of the items which is identified by an item ID=j (j=1 to m):
s₁, . . . , sₘ
   is transformed by the embedding model f′ to a corresponding item vector:
f(s₁), . . . , f(sₘ).

As an example, each item vector f′(uⱼ) is a d-dimensional vector.

The embedding model f′ may be different from the embedding model f, or may be the same as the embedding model f. Further, used as the embedding model f′ may be a function such as

$${f}^{′} ( s ) = f ( s + {}^{‶} a person interested in {…}^{″} ) ,$$

which is obtained by generating user text which expresses a user from text which expresses an item and including the user text as the argument of the embedding model f.

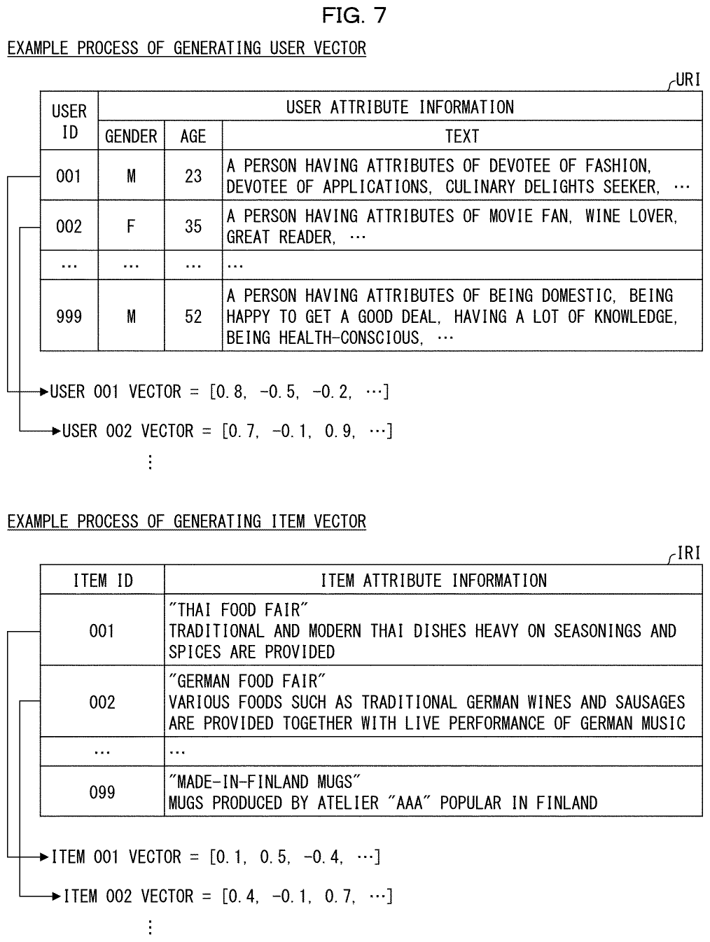

FIG. 7 indicates examples of more specific processes carried out by the transforming section 13. In the example illustrated in FIG. 7, the user-related information URI includes pieces of user attribute information regarding a plurality of users who are identified by user IDs=001 to 999, and each user attribute information includes the gender and the age of a corresponding user and text which expresses the user.

As an example, the transforming section 13 uses the above embedding model f to transform the user 001 who has the user attribute information “a person having attributes of devotee of fashion, devotee of applications, culinary delights seeker, . . . ”, to a user vector [0.8, −0.5, −0.2, . . . ].

As another example, the transforming section 13 uses the embedding model f to transform the user 002 who has the user attribute information “a person having attributes of movie fan, wine lover, great reader, . . . ”, to user vector [0.7, −0.1, 0.9, . . . ].

Similarly, in the example illustrated in FIG. 7, the item-related information IRI includes pieces of item attribute information regarding a plurality of items which are identified by item IDs=001 to 099, and each item attribute information includes text which expresses a corresponding item.

As an example, the transforming section 13 uses the above embedding model f′ to transform the item 001 which has the item attribute information “‘Thai food fair’ Traditional and modern Thai dishes heavy on seasonings and spices are provided”, to an item vector [0.1, 0.5, −0.4, . . . ].

As another example, the transforming section 13 uses the embedding model f′ to transform the item 002 which has the item attribute information “‘German food fair’ Various foods such as traditional German wines and sausages are provided together with live performance of German music”, to an item vector [0.4, −0.1, 0.7, . . . ].

A vector obtained through the transformation (generation) performed by the transforming section 13 is stored in the storage section 20 as vector information VI.

### (Predicting Section 14)

The predicting section 14 predicts compatibility between the user and the item with reference to the vector obtained through the transformation performed by the transforming section 13. As an example, the predicting section 14 may be configured to
derive a similarity between the user vector and the item vector that are generated by the transforming section 13, and
predict compatibility between the user and the item with reference to the similarity derived. For example, the predicting section 14 may calculate a similarity sim(u,s) between the user vector f(u) and the item vector f′(s), which are generated by the transforming section 13, with use of an inner product as follows:
   sim(u,s)=<f(u),f′(s)>, or may calculate the similarity sim(u,s) with use of a cosine similarity as follows:

$$sim ( u , s ) = \frac{< f ( u ) , {f}^{′} ( s ) >}{‖ f ( u ) ‖ ‖ {f}^{′} ( u ) ‖} \qquad ( Expression 1 )$$

If the similarity calculated as above is equal to or greater than a predetermined threshold, the predicting section 14 sets a reaction flag to 1 (determines that compatibility is good), otherwise sets the reaction flag to 0 (determines that the compatibility is poor). A specific method for setting the above threshold will be described later.

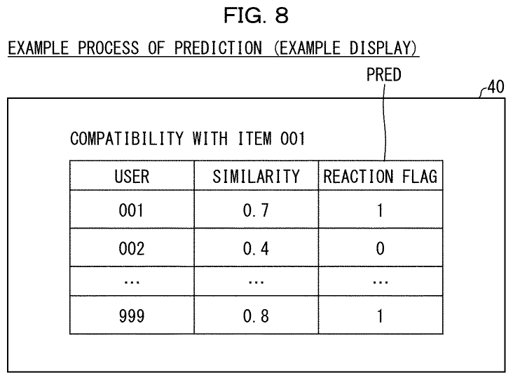

FIG. 8 is a diagram illustrating a specific example of a prediction result PRED derived by the predicting section 14 with reference to the above similarity. In the example illustrated in FIG. 8, the prediction result PRED includes information indicating compatibility between a certain item (item 001) and each user. In the example illustrated in FIG. 8, an example in which the above threshold is 0.65 is more specifically indicated, and the prediction result is derived as follows:
for the user 001 having the similarity to the item 001 which is 0.7, a reaction flag 1;
for the user 002 having the similarity to the item 001 which is 0.4, a reaction flag 0;
for the user 999 having the similarity to the item 001 which is 0.8, a reaction flag 1.
   Note that the threshold referred to by the predicting section 14 may be set in advance, or may be derived (set) by the predicting section 14 on the basis of training data. The process by which the predicting section 14 derives a threshold will be described later.

### (Output Section 15)

The output section 15 presents the prediction result PRED derived by the predicting section 14 to a user via the input-output section 40. As an example, the output section 15 may visually present the prediction result PRED illustrated in FIG. 8 to a user via the input-output section 40.

The output section 15 may present, to a user via the input-output section 40, some of the prompts PR (e.g., prompts PR1 to PR4, which will be described later) generated by the training section 23 (described later) or at least part of data generated by the trained model LM with reference to the prompts PR. Further, the output section 15 may accepts, via the input-output section 40, the prompts PR and an instruction from user for revising at least part of the data generated by the trained model LM, to revise appropriate data on the basis of the revision instruction.

### (Training Section 23)

The training section 23 uses training data to train the transforming section 13. The training data includes data generated by the trained model LM which refers to at least one piece of information selected from the group consisting of the information regarding a user and the information regarding an item, which are acquired by the acquiring section 11. As an example, the training section 23 may train the transforming section 13 by contrastive learning. For example, the training section 23 may train the transforming section 13 by contrastive learning such that
the similarity between an item and a positive sample related to the item increases, and
the similarity between an item and a negative sample related to the item decreases.

As an example, the training section 23 may perform the training by contrastive learning in which one or more of various algorithms such as SimCSE, Dense Passage Retrieval, and sentence-BERT.

In the above process, what data is used as the positive sample or the negative sample does not limit the present example embodiment, but as an example,
actual text of a user who has assigned the item a rating value (e.g., not less than 4 for rating values ranging from 1 to 5) equal to or greater than a predetermined value,
data generated by the trained model LM as text of a user who has assigned the item a rating value equal to or greater than a predetermined value,
   or the like can be used as the positive sample. Further,
actual text of a user who has assigned the item a rating value (e.g., less than 3 for rating values ranging from 1 to 5) smaller than a predetermined value,
data generated by the trained model LM as text of a user who has assigned the item a rating value smaller than a predetermined value, or the like can be used as the negative sample.

The training section 23 may train the transforming section 13 with reference to:
a first loss value obtained with reference to the data generated by the trained model LM; and
a second loss value obtained with reference to data other than the data generated by the trained model LM such that these loss values decrease. Note that in the following description, the data generated by the trained model LM can also be called a pseudo sample. In contrast to this, the data which is not the data generated by the trained model LM can also be called an actual sample. As an example, the actual sample is based on data inputted by a user themselves or another worker. Note that the above designations do not limit the present example embodiment.

### (Specific Example of Training Process Carried Out by Training Section 23 and Transforming Section 13)

Here is a specific example of the training process carried out by the training section 23 and the transforming section 13.

### (Problem Setting)

Problem setting (various definitions) in the present example is described first. In the following description,
a set of users is denoted by U,
a set of items is denoted by I, and
the score (which can be referred to as a correlation score) of interaction between a user U (u is an element of the set U) and an item i (i is an element of the set I) is denoted by r_{u,i}.

The r_{u,i} is an element of an observed interaction set R, and the set R is defined by the following expression.

$$R := \{ ( u , i , {r}_{u , i} ) \vert u ∈ U , i ∈ I , {r}_{u , i} is observed \} \qquad ( Expression 2 )$$

Further, as a set U_{w} of warm-start users, a user who belongs to the set R is defined by the following expression.

$${U}_{w} := \{ u \vert u exists in R \} \qquad ( Expression 3 )$$

A set U_{c} of users (cold-start users) who do not belong to the set R is defined by the following expression.

$${U}_{c} := U \backslash {U}_{w} \qquad ( Expression 4 )$$

A set U_{w} of warm-start items and a set U_{c} of cold-start items are defined similarly. Further,
text as subsidiary information (which can also be called side information) regarding a user is denoted by tᵤ, and
text as subsidiary information (side information) regarding an item is denoted by tᵢ.

The text tᵤ can be understood to be an example of the user attribute information above. Further, the text tᵢ can be understood to be an example of the item attribute information above. As an example, as the text tᵤ and the text tᵢ, data (actual sample) which is not data generated by the trained model LM is used.

These pieces of text tᵤ and tᵢ are transformed to the vector representation below, with use of, for example, an algorithm such as the term frequency-inverse document frequency (TF-IDF) algorithm or the BERT algorithm which is carried out by the transforming section 13.

$${x}_{u} , {x}_{i} ∈ {R}^{d} \qquad ( Expression 5 )$$

### (Presupposed Framework)

Next, a presupposed framework in the transformation process carried out by the transforming section 13 is described here. Although the framework described below can be understood to be, for example, the so-called Heater algorithm disclosed in Document 1, this wording does not limit the present example embodiment.

In the present example, as partially described above, a user u and an item i are transformed by the transforming section 13 to vectors f(u) and f′ (i). The f(u) and f′ (i) are each a vector in an 1-dimensional space. Although such transformations to the vectors can be performed with use of a configuration adopted in a recommendation system typified by, as an example, Matrix Factorization (MF), this example does not limit the present example embodiment.

The predicting section 14 generates a predicted value \hat{ }r_{u,i} (r_{u,i}-hat) of the similarity, by the following expression.

$${\hat{r}}_{u , i} := 〈 f ( u ) , {f}^{′} ( i ) 〉 \qquad ( Expression 6 )$$

In Matrix Factorization cited as an example, the observed interaction R is used as training data, and a latent representation for the user u and the item i,

$${p}_{u} , {q}_{i} ∈ {ℝ}^{k} \qquad ( Expression 7 )$$

is trained so that r_{u,i} approaches <pᵤ, qᵢ>. The embedding in the above latent space in Matrix Factorization cited as an example is limited to in a case of warm start, and is not applicable to a case of cold start.

In contrast, in the processes carried out by the transforming section 13, etc. in the presupposed framework of the present example, embedding derived from the side information is to be learned. Although this can be understood to be a process similar to collaborative filtering embedding, this wording does not limit the present example embodiment.

In the presupposed framework, first of all, side information xᵤ regarding a user is mapped to a collaborative filtering embedding space as follows.

$${Wx}_{u} ∈ {ℝ}^{k} \qquad ( Expression 8 )$$

A similar linear transformation W′ is applied to side information xi regarding an item. Furthermore, another type of linear transformation

$$V , {V}^{′} ∈ {ℝ}^{k \times ℓ} \qquad ( Expression 9 )$$

is also used. The training process is carried out such that <Vpᵤ, V′qᵢ> approaches r_{u,i}, and <VWXᵤ, V′qᵢ> is also trained so as to approach r_{u,i}. This process is applied also to the item side.

In an optimization process in the presupposed framework, a parameter

$$Θ = ( P , Q , W , {W}^{′} , V , {V}^{′} ) \qquad ( Expression 10 )$$

is updated such that the loss function below is minimized. In other words, the training section 23 updates the above parameter to be used by the transforming section 13 in the transforming process, so as to minimize the following loss function.

$${ℒ}_{heater} := {ℒ}_{Base} + {λ}_{Side} {ℒ}_{Side} + {λ}_{Θ} {‖ Θ ‖}_{F} \qquad ( Expression 11 )$$

$$where$$

$${ℒ}_{Base} := {\sum }_{( u , i , {r}_{u , i} ) ∈ R} {\vert {r}_{u , i} - 〈 f ( u , p ) , {f}^{′} ( i , {p}^{′} ) 〉 \vert}^{2}$$

$${ℒ}_{Side} := {\sum }_{u ∈ {U}_{w}} {‖ {Wx}_{u} - {p}_{u} ‖}^{2} + {\sum }_{i ∈ {I}_{w}} {‖ {W}^{′} {x}_{i} - {q}_{i} ‖}^{2}$$

For the following probability

$$p ∈ [ 0 , 1 ] \qquad ( Expression 12 )$$

the mapping f(u,p) takes on VWxᵤ, otherwise takes on Vpᵤ. Similarly, the mapping f′ is applicable also to an item. Although such a stochastic mapping can also be referred to as randomized training, this wording does not limit the present example embodiment.

It is expected that <Vpu, V′W′xᵤ> becomes close to the actual reaction (interaction) r_{u,i} for a warm-start user u and a cold-start item i after the completion of the above training. What is important here is that it is possible to make such inference with use of side information only, without using collaborative filtering. Further, it is also important that the above process is carried out by calculations of an inner product and a matrix product, and does not includes a high cost process.

(Training Process Carried Out by Training Section 23 and Transforming Section 13 in Accordance with Present Example)

The training section 23 and the transforming section 13 in accordance with the present example carry out a process in consideration of contributions of not only the above-described presupposed framework but also a pseudo sample (data generated by the trained model LM). More specifically, the training section 23 updates the above parameter to be used by the transforming section 13 in the transforming process, so as to minimize the following loss function.

$${ℒ}_{stove} := {ℒ}_{heater} + {λ}_{aug} {ℒ}_{aug} \qquad ( Expression 13 )$$

$$where$$

$${ℒ}_{aug} := {\sum }_{( u , i , {r}_{u , i} ) ∈ {R}_{g}^{u}} {\vert {r}_{u , i} - 〈 f ( u , 1 ) , {f}^{′} ( i , 0 ) 〉 \vert}^{2} + {\sum }_{( u , i , {r}_{u , i} ) ∈ {R}_{g}^{i}} {\vert {r}_{u , i} - 〈 f ( u , 0 ) , {f}^{′} ( i , 1 ) 〉 \vert}^{2}$$

In Expression 13, R_{g}^{u} and R_{g}ⁱ are each a set of pseudo samples (data generated by the trained model LM), and are each formed by, for example,
(User ID, item text, rating)
(user text, item ID, rating), or
(user text, item text, rating).
   Further, the coefficient λ_{aug} of the second term of the loss function Lₛₜₒᵥₑ is a weight coefficient which defines the contribution, to the loss function Lₛₜₒᵥₑ, of a loss coming from the pseudo samples, and may be set to a value less than 1, or may be set to a value not less than 1.

As above, the training section 23 trains the transforming section 13 with use of the loss function (Lₛₜₒᵥₑ) in which respective weights different from each other are applied to
the first loss value (e.g. L_{aug} above) obtained with reference to data (pseudo samples) generated by the trained model LM, and
the second loss value (e.g. Lₕₑₐₜₑᵣ) obtained with reference to data (actual samples) other than the data generated by the trained model LM.

### (Example of Pseudo Sample Generation Carried Out by Training Section 23)

Here is the description of an example generation of a pseudo sample to be used by the training section 23 for training the transforming section 13. As partially described above, as an example, the training section 23 uses data (pseudo samples) generated by the trained model LM, to train the transforming section 13.

As an example, the training section 23 carries out the process of:
generating one or more prompts PR with reference to information (at least one piece of information selected from the group consisting of information regarding a user and information regarding an item) acquired by the acquiring section 11 (12, 21, 22),
inputting the generated one or more prompts PR to the trained model LM via the communicating section 30, and
generating the above pseudo sample based on data (a response made by the trained model LM) outputted by the trained model LM.

Here is the description of examples of a pseudo sample generated based on a prompt PR generated by the training section 23, a response made by the trained model LM to prompt PR, and a pseudo sample generated based on the response.

### Example 1

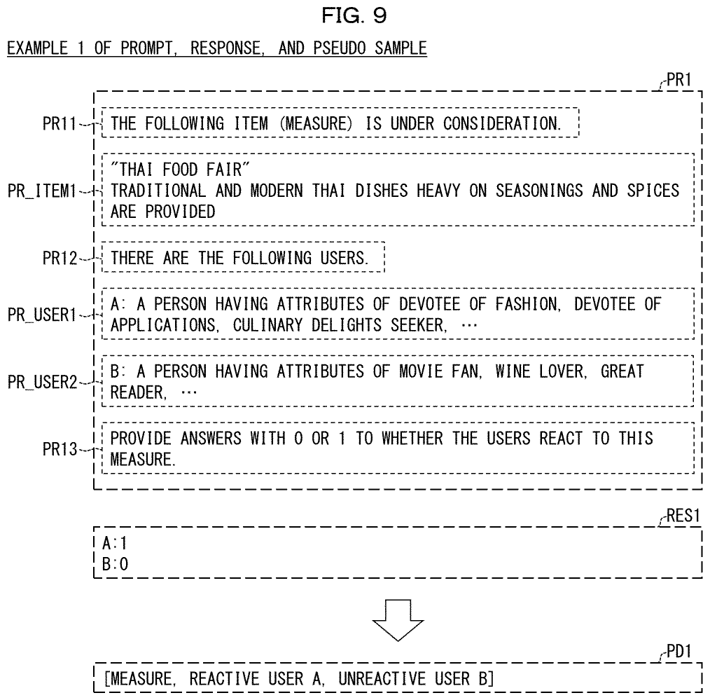

FIG. 9 is a diagram illustrating example 1 regarding prompts PR generated by the training section 23, a response made by the trained model LM, and a pseudo sample. As illustrated in FIG. 9, a prompt PR1 generated by the training section 23 includes
text (PR11 in FIG. 9) which indicates that there is an item (measure) under consideration,
text (PR_ITEM1) which indicates the details of the item under consideration,
text (PR12) which indicates that there are users,
one or more pieces of text (PR_USER1 and PR_USER2) which express the users, and
text (PR13) for querying about whether the users react to the item (measure).

In the example illustrated in FIG. 9, upon input of the prompt PR1, the trained model LM then generates
a response (RES1) which indicates that a user A reacts to the item, and a user B does not react to the item and provides the training section 23 with the response. With reference to the response RES1, the training section 23 then generates a pseudo sample PD1 which includes
at least one selected from the group consisting of the ID and the text of the item (measure),
text (positive sample) regarding the user A as the user who reacts to the item (measure), and
text (negative sample) regarding the user B as the user who does not react to the item (measure).
   The pseudo sample PD1 thus generated is referred to for, e.g., the calculation of the loss function L_{aug}, and is used for the training of the transforming section 13 carried out by the training section 23.

### Example 2

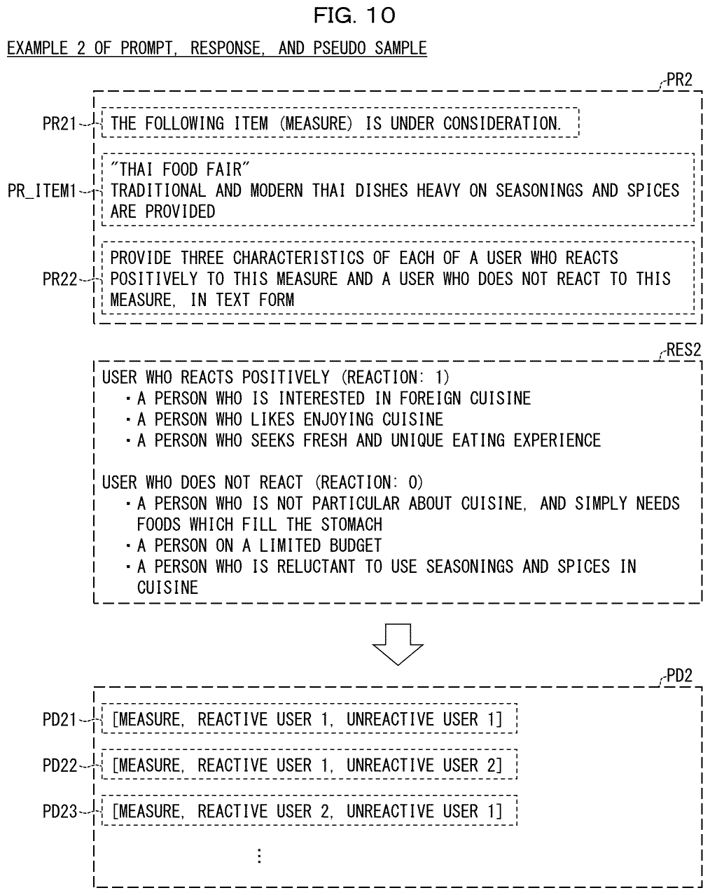

FIG. 10 is a diagram example 2 regarding prompts PR generated by the training section 23, a response made by the trained model LM, and a pseudo sample. As illustrated in FIG. 10, a prompt PR2 generated by the training section 23 includes
text (PR21 in FIG. 10) which indicates that there is an item (measure) under consideration,
text (PR_ITEM1) which indicates the details of the item under consideration, and
text (PR22) for making a query about characteristics of the user who reacts positively to the item (measure) and characteristics of the user who does not react to the item (measure).

In the example illustrated in FIG. 10, as an example, a response RES2 generated by the trained model LM upon input of the prompt PR2 is formed so as to include pieces of text below which express characteristics of the users who react positively:
a person who is interested in foreign cuisine (reactive user 1);
a person who likes enjoying cuisine (reactive user 2); and
a person who seeks fresh and unique eating experience (reactive user 3),
   and pieces of text below which express characteristics of the users who do not react:
a person who is not particular about cuisine, and simply needs foods which fill the stomach (unreactive user 1),
a person on a limited budget (unreactive user 2), and
a person who is reluctant to use seasonings and spices in cuisine (unreactive user 3).

With reference to the response RES2, the training section 23 generates a pseudo sample PD21 which includes:
at least one selected from the group consisting of the ID and the text of the item (measure),
the text (positive sample) regarding the reactive user 1 as the user who reacts to the item (measure),
the text (negative sample) regarding the unreactive user 1 as the user who does not react to the item (measure). Further, the training section 23 combines the item (measure) and the text regarding another user, to also generate pseudo samples PD22, PD23, and so on. In the present example, the training section 23 can generate a pseudo sample group PD2 which includes 9 (=3×3) pseudo samples. The pseudo sample PD2 thus generated is referred to for, e.g., the calculation of the loss function L_{aug}, and is used for the training of the training of the transforming section 13 carried out by the training section 23.

As in the present example, it is possible to use prompts to query the trained model LM about a plurality of characteristics of users and thereby generate a pseudo sample which includes many combinations. This enables the training section 23 to more suitably train the transforming section 13.

### Example 3

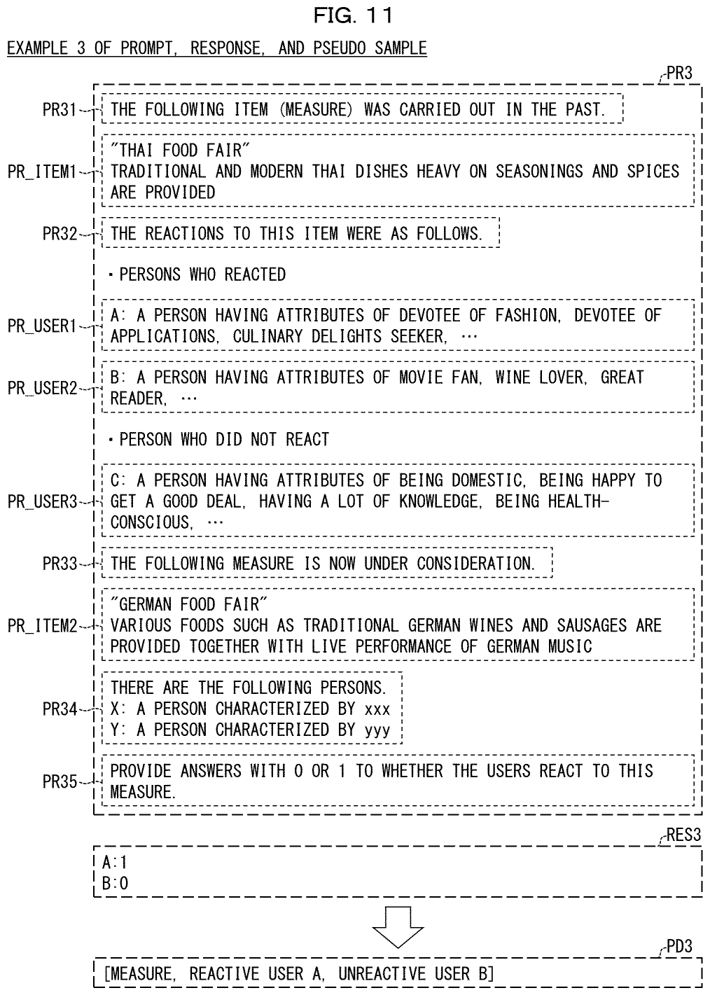

FIG. 11 is a diagram illustrating example 3 regarding prompts PR generated by the training section 23, a response made by the trained model LM, and a pseudo sample. As illustrated in FIG. 11, a prompt PR3 generated by the training section 23 includes
text (PR31 in FIG. 11) which indicates that an item (measure) was carried out in the past,
text (PR_ITEM1) which indicates the details of the item (measure) carried out in the past,
a group of pieces of text (PR32, PR_USER1, PR_USER2, PR_USER 3) which explains the reactions of users in response to the item (measure) carried out in the past,
text (PR33) which indicates that there is an item (measure) under consideration,
text (PR_ITEM2) which indicates the details of the item under consideration,
pieces of text (PR34) which indicates that there are users and expresses the users, and
text (PR35) for querying about whether the users react to the item (measure).

In the example illustrated in FIG. 11, upon input of the prompt PR3, the trained model LM then generates
a response (RES3) which indicates that a user A reacts to the item, and a user B does not react to the item and provides the training section 23 with the response. With reference to the response RES3, the training section 23 then generates a pseudo sample PD3 which includes
at least one selected from the group consisting of the ID and the text of the item (measure),
text (positive sample) regarding the user A as the user who reacts to the item (measure), and
text (negative sample) regarding the user B as the user who do not react to the item (measure).
   The pseudo sample PD1 thus generated is referred to for, e.g., the calculation of the loss function L_{aug}, and is used for the training of the transforming section 13 carried out by the training section 23.

By including, in a prompt, an item (measure) which was carried out in the past and the reactions of users in response to the item (measure), as in the present example, it is possible to obtain a more suitable response from the trained model LM. This enables the training section 23 to generate a more suitable pseudo sample PD.

### Example 4

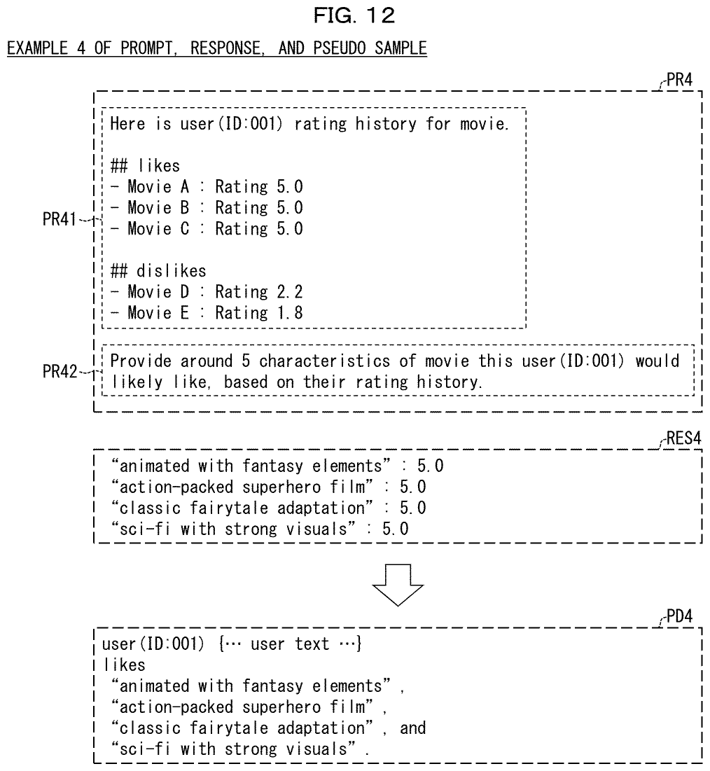

FIG. 12 is a diagram illustrating example 4 regarding prompts PR generated by the training section 23, a response made by the trained model LM, and a pseudo sample. As illustrated in FIG. 12, a prompt PR4 generated by the training section 23 includes
a rating history (PR41) of ratings assigned by a certain user (a user having the user ID 001 in the example of FIG. 12) to one or more items (Movie A to Movie E in the example of FIG. 12), and
text (PR42) for making, based on the rating history, a query about characteristics of an item (movie) the user would likely like.

In other words, the prompt PR4 in accordance with the present example includes a query sentence (PR42) for making, based on information from a user acquired by the acquiring section 11 (12, 21, 22), a query about information regarding one or more items.

In the example illustrated in FIG. 12, upon input of the prompt PR4, the trained model LM then generates
a response (RES4) below which includes characteristics of an item (movie) the user would likely like and ratings expected to be assigned by the user to the characteristics
   “animated with fantasy elements”: 5.0
   “action-packed superhero film”: 5.0
   “classic fairytale adaptation”: 5.0.
   “sci-fi with strong visuals”: 5.0
      is generated, and is provided to the training section 23. With reference to the response RES4, the training section 23 then generates a pseudo sample PD4 which includes
at least one selected from the group consisting of the ID and the text of the user, and
characteristics of movies the user likes.
   The pseudo sample PD4 thus generated is referred to for, e.g., the calculation of the loss function L_{aug}, and is used for the training of the training of the transforming section 13 carried out by the training section 23.

The prompt PR4 in accordance with the present example includes the query sentence (PR42) for making, based on information from a user acquired by the acquiring section 11 (12, 21, 22), a query about information regarding an item. This makes it possible to acquire a useful response from the trained model LM. This enables the training section 23 to generate a more suitable pseudo sample PD.

As above, the training section 23
acquires data (pseudo sample) generated by the trained model LM with reference to information (at least one piece of information selected from the group consisting of information regarding a user and information regarding an item) acquired by the first acquiring section 11 (12, 21, 22), and
trains one or more transforming sections 13 for performing a transformation to a vector on each of the user and the item with use of training data which includes the data (pseudo sample) generated by the trained model LM,
   and it is therefore possible to increase the amount of training data. Further, the transforming sections 13 trained with use of such training data and the predicting section 14 carry out a predicting process using a transformation to a vector. This eliminates the need for the access to the trained model LM in an inference phase. This makes it possible to provide a recommendation technique which makes it possible to cope with the cold start problem while limiting an increase in cost.

### (Process for Calculating Threshold Referred to by Predicting Section 14)

Here is the description of a process for calculating a threshold referred to by the predicting section 14. The predicting section 14 can
set (derive) a threshold with reference to a similarity between pieces of data which are included in training data referred to by the training section 23, and
carry out the above predicting process with reference to the set (derived) threshold.
   As an example, with reference to one or more pairs used by the training section 23 in a training phase, the predicting section 14 may calculate
a similarity (first similarity) of a pair of an item (measure) and a positive sample for the item, and
a similarity (second similarity) of a pair of an item (measure) and a negative sample for the item,
   and set the threshold to a value intermediate between the first similarity and the second similarity.

For example, the predicting section 14 may calculate
similarities (first similarities: S_pos) of pairs of a measure (item) and a positive sample, and
similarities (second similarities: S_neg) of pairs of a measure (item) and a negative sample,
   and use the mean (mean (S_pos)) of the similarities for positive samples and the mean (mean (S_neg)) for negative samples, to derive the threshold by

Threshold=(mean(S_pos)+mean(s_neg))/2.

Alternatively, the predicting section 14
may derive the threshold by calculating the mean between a negative sample of a similarity greater than the lowest similarity among those for the positive samples that are being learned and a positive sample of a similarity less than the highest similarity among those for the negative samples that are being learned. In other words, the predicting section 14 may derive the threshold by the following expression.

$$\begin{matrix}Thres - \\ hold\end{matrix} = mean ( \{ s \vert s ∈ S\_pos , s < max ( S\_neg ) \} ⋃ \{ s \vert s ∈ S\_neg , s > min ( S\_pos \} ) \qquad ( Expression 14 )$$

With this configuration, it is possible to suitably set a threshold with reference to training data. This enables the predicting section 14 to carry out a suitable predicting process.

### Third Example Embodiment

The following description will discuss a second example embodiment, which is an example embodiment of the present invention, in detail with reference to the drawings. A component having the same function as a component described in the above example embodiment is assigned the same reference sign, and the description thereof is omitted where appropriate. It should be noted that the applicability of the techniques adopted in the present example embodiment is not limited to the present example embodiment. That is, the techniques adopted in the present example embodiment can be adopted in another example embodiment included in the present disclosure, to the extent of constituting no specific technical obstacle. Further, the techniques illustrated in the drawings referred to for the description of the present example embodiment can be adopted in another example embodiment included in the present disclosure, to the extent of constituting no specific technical obstacle.

### (Configuration of Information Processing Apparatus 200)

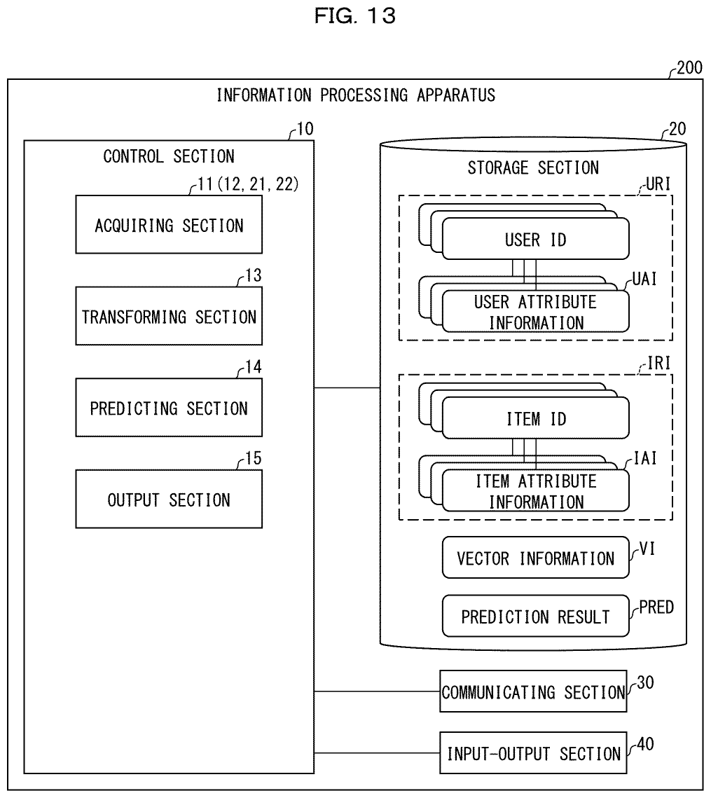

The configuration of an information processing apparatus 200 in accordance with the present example embodiment is described here with reference to FIG. 13. As illustrated in FIG. 13, the information processing apparatus 200 includes the components of the information processing apparatus 100 in accordance with the second example embodiment except the training section 23. The other components are the same as those of the information processing apparatus 100.

As an example, the information processing apparatus 200 in accordance with the present example embodiment includes transforming sections 13 trained by the training section 23 of the information processing apparatus 100 in accordance with the second example embodiment. As above, the information processing apparatus 200 includes
a first acquiring means (acquiring section 11 (12, 21, 22)) for acquiring information regarding a user,
a second acquiring means (acquiring section 11 (12, 21, 22)) for acquiring information regarding an item,
one or more transforming means (transforming sections 13) for performing a transformation to a vector on each of the information regarding the user and the information regarding the item, the one or more transforming means being trained with use of training data which includes data generated by a trained model, and
a predicting means (predicting section 14) for predicting compatibility between the user and the item with reference to the vector obtained through the transformation performed by the transforming means.
   This configuration also provides various example advantages in accordance with the example embodiments above.

### Additional Remarks Regarding Example Embodiments

Although in the above description, examples are cited as to the case where compatibility between a user and an item is learned and predicted, these examples do not limit the matters described in the present specification. As an example, the information processing apparatus 100 may be expressed as including
a first acquiring means for acquiring information regarding a first object (a user for example),
a second acquiring means for acquiring information regarding a second object (an item for example),
one or one or more transforming means for performing a transformation to a vector on each of the information regarding the first object and the information regarding the second object, the one or more transforming means being trained with use of training data which includes data generated by a trained model, and
a predicting means for predicting compatibility between the first object and the second object with reference to the vector obtained through the transformation performed by the transforming means.

Further, the information processing apparatus 100 may be expressed as including
a first acquiring means for acquiring at least one piece of information selected from the group consisting of information regarding a first object (a user for example) and information regarding a second object (an item for example),
a second acquiring means for acquiring, with reference to the at least one piece of information acquired by the first acquiring means, data generated by a trained model; and
a training means for training one or more transforming means with use of training data which includes the data acquired by the second acquiring means, the one or more transforming means being for performing a transformation to a vector on each of the first object and the second object.

With this configuration, it is possible to provide recommendation technique which makes it possible to cope with the cold start problem while limiting an increase in cost.

### [Software Implementation Example]

Some or all of the functions of each of the information processing apparatuses 1, 2, 100, and 200 (hereinafter, also referred to as “each apparatus above”) may be implemented by hardware such as an integrated circuit (IC chip), or may be implemented by software.

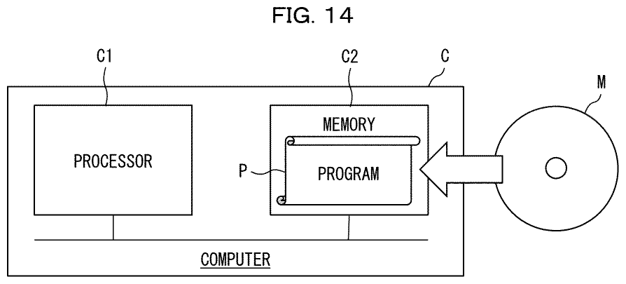

In the latter case, each apparatus above is provided by, for example, a computer that executes instructions of a program that is software implementing the functions. An example (hereinafter, computer C) of such a computer is illustrated in FIG. 14. FIG. 14 is a block diagram illustrating a hardware configuration of the computer C which functions as each apparatus above.

The computer C includes at least one processor C1 and at least one memory C2. The memory C2 has recorded thereon a program P for causing the computer C to operate as each apparatus above. The processor C1 of the computer C retrieves the program P from the memory C2 and executes the program P, so that the functions of each apparatus above are implemented.

Examples of the processor C1 can include a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, and a combination thereof. Examples of the memory C2 can include a flash memory, a hard disk drive (HDD), a solid state drive (SSD), and a combination thereof.

The computer C may further include a random access memory (RAM) into which the program P is loaded at the time of execution and in which various kinds of data are temporarily stored. The computer C may further include a communication interface via which data is transmitted to and received from another apparatus. The computer C may further include an input-output interface via which input-output equipment such as a keyboard, a mouse, a display, or a printer is connected.

The program P can be recorded on a non-transitory tangible recording medium M capable of being read by the computer C. The recording medium M can be, for example, a tape, a disk, a card, a semiconductor memory, a programmable logic circuit, or the like. The computer C can obtain the program P via such a recording medium M. The program P can be transmitted via a transmission medium. Examples of such a transmission medium can include a communication network and a broadcast wave. The computer C can obtain the program P also via such a transmission medium.

### Additional Remark A

The whole or part t of the example embodiments disclosed above can be described as, but not limited to, the following supplementary notes. Note, however, that the present invention is not limited to the techniques described in the supplementary notes below, but may be altered in various ways by a skilled person within the scope of the claims.

### Supplementary Note A1

An information processing apparatus, including:
a first acquiring means for acquiring information regarding a user;
a second acquiring means for acquiring information regarding an item;
one or more transforming means for performing a transformation to a vector on each of the information regarding the user and the information regarding the item, the one or more transforming means being trained with use of training data which includes data generated by a trained model, and
predicting means for predicting compatibility between the user and the item with reference to the vector obtained through the transformation performed by the transforming means.

### Supplementary Note A2

The information processing apparatus described in supplementary note A1, in which the item includes at least one selected from the group consisting of a product and a measure.

### Supplementary Note A3

The information processing apparatus described in supplementary note A1 or A2, in which
the one or more transforming means are trained with use of a loss function in which respective weights different from each other are applied to:
   a first loss value obtained with reference to the data generated by the trained model; and
   a second loss value obtained with reference of data other than the data generated by the trained model.

### Supplementary Note A4

The information processing apparatus described in any one of supplementary notes A1 to A3, in which
the predicting means is configured to
   predict the compatibility between the user and the item with reference to a threshold set with reference to a similarity between pieces of data which are included in the training data.

### Supplementary Note A5

The information processing apparatus described in any one of supplementary notes A1 to A4, in which
the predicting means is configured to
   derive a similarity between a vector for the user and a vector for the item that are generated by the one or more transforming means, and
   predict the compatibility between the user and the item with reference to the similarity derived.

### Supplementary Note A6

The information processing apparatus described in any one of supplementary notes A1 to A5, in which
the one or more transforming means are trained by contrastive learning.

### Supplementary Note A7

An information processing apparatus, including:
a first acquiring means for acquiring at least one piece of information selected from the group consisting of information regarding a user and information regarding an item;
a second acquiring means for acquiring, with reference to the at least one piece of information acquired by the first acquiring means, data generated by a trained model; and
a training means for training one or more transforming means with use of training data which includes the data acquired by the second acquiring means, the one or more transforming means being for performing a transformation to a vector on each of the user and the item.

### Supplementary Note A8

The information processing apparatus described in supplementary note A7, in which
the second acquiring means is configured to
generate one or more prompts with reference to the at least one piece of information acquired by the first acquiring means, and
acquire, as the data generated by the trained model, data outputted by the trained model which has inputted thereto the one or more prompts generated.

### Supplementary Note A9

The information processing apparatus described in supplementary note A8, in which the one or more prompts include a query sentence for making, based on information from the user acquired by the first acquiring means, a query about the information regarding the item.

### Supplementary Note A10

The information processing apparatus described in any one of supplementary notes A7 to A9, in which
the transforming means is configured to train the one or more transforming means with use of a loss function in which respective weights different from each other are applied to:
   a first loss value obtained with reference to the data generated by the trained model; and
   a second loss value obtained with reference to data other than the data generated by the trained model.

### Supplementary Note A11

The information processing apparatus described in any one of supplementary notes A7 to A10, in which
the training means is configured to train
the one or more transforming means by contrastive learning.

### Additional Remark B

The whole or part of the example embodiments disclosed above can be described as, but not limited to, the following supplementary notes. Note, however, that the present invention is not limited to the techniques described in the supplementary notes below, but may be altered in various ways by a skilled person within the scope of the claims.

### Supplementary Note B1

An information processing method, including:
at least one processor acquiring information regarding a user;
the at least one processor acquiring information regarding an item;
the at least one processor performing a transformation to a vector on each of the information regarding the user and the information regarding the item via one or more transforming means, the one or more transforming means being trained with use of training data which includes data generated by a trained model; and
the at least one processor predicting compatibility the user and the item with reference to the vector obtained by the performing of the transformation.

### Supplementary Note B2

The information processing method described in supplementary note B1, in which
the item includes at least one selected from the group consisting of a product and a measure.

### Supplementary Note B3

The information processing method described in supplementary note B1 or B2, in which
the one or more transforming means are trained with use of a loss function in which respective weights different from each other are applied to:
   a first loss value obtained with reference to the data generated by the trained model; and
   a second loss value obtained with reference of data other than the data generated by the trained model.

### Supplementary Note B4

The information processing method described in any one of supplementary notes B1 to B3, in which
in the predicting, the at least one processor
   predicts the compatibility between the user and the item with reference to a threshold set with reference to a similarity between pieces of data which are included in the training data.

### Supplementary Note B5

The information processing method described in any one of supplementary notes B1 to B4, in which
in the predicting, the at least one processor
   derives a similarity between a vector for the user and a vector for the item that are generated by the performing of the transformation, and
   predicts the compatibility between the user and the item with reference to the similarity derived.

### Supplementary note B6

The information processing method described in any one of supplementary notes B1 to B5, in which the one or more transforming means are trained by contrastive learning.

### Supplementary Note B7

An information processing method, including:
at least one processor acquiring at least one piece of information selected from the group consisting of information regarding a user and information regarding an item;
the at least one processor acquiring, with reference to the at least one piece of information acquired by the acquiring, data generated by a trained model; and
the at least one processor training one or more transforming means with use of training data which includes the data acquired by the acquiring, the one or more transforming means being for performing a transformation to a vector on each of the user and the item.

### Supplementary Note B8

The information processing method described in supplementary note B7, in which
in the acquiring of the data,
   one or more prompts are generated with reference to the at least one piece of information acquired by the acquiring, and
   data outputted by the trained model which has inputted thereto the one or more prompts generated is acquired as the data generated by the trained model.

### Supplementary Note B9

The information processing method described in supplementary note B8, in which
the one or more prompts include
   a query sentence for making, based on information from the user acquired by the acquiring of the at least one piece of information, a query about the information regarding the item.

### Supplementary Note B10

The information processing method described in any one of supplementary notes B7 to B9, in which
the at least one processor trains the one or more transforming means with use of a loss function in which respective weights different from each other are applied to:
   a first loss value obtained with reference to the data generated by the trained model; and
   a second loss value obtained with reference to data other than the data generated by the trained model.

### Supplementary Note B11

The information processing method described in any one of supplementary notes B7 to B10, in which
in the training,
the at least one processor trains the one or more transforming means by contrastive learning.

### Additional Remark C

The whole or part of the example embodiments disclosed above can be described as, but not limited to, the following supplementary notes. Note, however, that the present invention is not limited to the techniques described in the supplementary notes below, but may be altered in various ways by a skilled person within the scope of the claims.

### Supplementary Note C1

An information processing program for causing a computer to: function as an information processing apparatus,
the program causing the computer to function as:
   a first acquiring means for acquiring information regarding a user;
   a second acquiring means for acquiring information regarding an item;
   one or more transforming means for performing a transformation to a vector on each of the information regarding the user and the information regarding the item, the one or more transforming means being trained with use of training data which includes data generated by a trained model, and
   a predicting means for predicting compatibility between the user and the item with reference to the vector obtained through the transformation performed by the one or more transforming means.

### Supplementary Note C2

The information processing program described in supplementary note C1, in which the item includes at least one selected from the group consisting of a product and a measure.

### Supplementary Note C3

The information processing program described in supplementary note C1 or C2, in which
the one or more transforming means are trained with use of a loss function in which respective weights different from each other are applied to:
   a first loss value obtained with reference to the data generated by the trained model; and
   a second loss value obtained with reference of data other than the data generated by the trained model.

### Supplementary Note C4

The information processing program described in any one of supplementary notes C1 to C3, in which
the predicting means is configured to
   predict the compatibility between the user and the item with reference to a threshold set with reference to a similarity between pieces of data which are included in the training data.

### Supplementary Note C5

The information processing program described in any one of supplementary notes C1 to C4, in which
the predicting means is configured to
   derive a similarity between a vector for the user and a vector for the item that are generated by the one or more transforming means, and
   predict the compatibility between the user and the item with reference to the similarity derived.

### Supplementary Note C6

The information processing program described in any one of supplementary notes C1 to C5, in which the one or more transforming means are trained by contrastive learning.

### Supplementary Note C7

An information processing program causing a computer to function as:
a first acquiring means for acquiring at least one piece of information selected from the group consisting of information regarding a user and information regarding an item;
a second acquiring means for acquiring, with reference to the at least one piece of information acquired by the first acquiring means, data generated by a trained model; and
a training means for training one or more transforming means with use of training data which includes the data acquired by the second acquiring means, the one or more transforming means being configured to perform a transformation to a vector on each of the user and the item.

### Supplementary Note C8

The information processing program described in supplementary note C7, in which
the second acquiring means is configured to
   generate one or more prompts with reference to the at least one piece of information acquired by the first acquiring means, and
   acquire, as the data generated by the trained model, data outputted by the trained model which has inputted thereto the one or more prompts generated.

### Supplementary Note C9

The information processing program described in supplementary note C8, in which
the one or more prompts include
   a query sentence for making, based on information from the user acquired by the first acquiring means, a query about the information regarding the item.

### Supplementary Note C10

The information processing program described in any one of supplementary notes C7 to C9, in which
the transforming means is configured to train the one or more transforming means with use of a loss function in which respective weights different from each other are applied to:
   a first loss value obtained with reference to the data generated by the trained model; and
   a second loss value obtained with reference to data other than the data generated by the trained model.

### Supplementary Note C11

The information processing program described in any one of supplementary notes C7 to C10, in which the training means is configured to train
the one or more transforming means by contrastive learning.

### Additional Remark D

The whole or part of the example embodiments disclosed above can be described as, but not limited to, the following supplementary notes. Note, however, that the present invention is not limited to the techniques described in the supplementary notes below, but may be altered in various ways by a skilled person within the scope of the claims.

### Supplementary Note D1

An image generation apparatus, including at least one processor, the at least one processor carrying out:
a first acquiring process of acquiring information regarding a user;

a second acquiring process of acquiring information regarding an item;

a transforming process of performing a transformation to a vector on each of the information regarding the user and the information regarding the item with use of one or more transforming means, the one or more transforming means being trained with use of training data which includes data generated by a trained model; and
a predicting process of predicting compatibility between the user and the item with reference to the vector obtained through the transformation performed by the transforming process.

The information processing apparatus may further include a memory. The memory may have stored therein a program for causing the at least one processor to carry out each of the processes.

### Supplementary Note D2

The information processing apparatus described in supplementary note D1, in which the item includes at least one selected from the group consisting of a product and a measure.

### Supplementary Note D3

The information processing method described in supplementary note D1 or D2, in which
the one or more transforming means are trained with use of a loss function in which respective weights different from each other are applied to:
   a first loss value obtained with reference to the data generated by the trained model; and
   a second loss value obtained with reference of data other than the data generated by the trained model.

### Supplementary Note D4

The information processing apparatus described in any one of supplementary notes D1 to D3, in which
in the predicting process, the at least one processor
   predicts the compatibility between the user and the item with reference to a threshold set with reference to a similarity between pieces of data which are included in the training data.

### Supplementary Note D5

The information processing apparatus described in any one of supplementary notes D1 to D4, in which
in the predicting process, the at least one processor
   derives a similarity between a vector for the user and a vector for the item that are generated by the transforming process, and
   predicts the compatibility between the user and the item with reference to the similarity derived.

### Supplementary Note D6

The information processing apparatus described in any one of supplementary notes D1 to D5, in which the one or more transforming means are trained by contrastive learning.

### Supplementary Note D7

An information processing apparatus, including at least one processor, the at least one processor carrying out:
a first acquiring process of acquiring at least one piece of information selected from the group consisting of information a regarding user and information regarding an item;
a second acquiring process of acquiring, with reference to the at least one piece of information acquired by the first acquiring process, data generated by a trained model; and
a training process of training one or more transforming means with use of training data which includes the data acquired by the second acquiring process, the one or more transforming means being configured to perform a transformation to a vector on each of the user and the item.

### Supplementary Note D8

The information processing apparatus described in supplementary note D7, in which
in the second acquiring process,
   one or more prompts are generated with reference to the at least one piece of information acquired by the first acquiring process, and
   data outputted by the trained model which has inputted thereto the one or more prompts generated is acquired as the data generated by the trained model.

### Supplementary Note D9

The information processing apparatus described in supplementary note D8, in which
the one or more prompts include
   a query sentence for making, based on information from the user acquired by the first acquiring process, a query about the information regarding the item.

### Supplementary Note D10

The information processing apparatus described in any one of supplementary notes D7 to D9, in which
in the training process, the at least one processor trains the one or more transforming means with use of a loss function in which respective weights different from each other are applied to:
   a first loss value obtained with reference to the data generated by the trained model; and
   a second loss value obtained with reference to data other than the data generated by the trained model.

### Supplementary Note D11

The information processing apparatus described in any one of supplementary notes D7 to D10, in which in the training process, the at least one processor
trains the one or more transforming means by contrastive learning.

### Additional Remark E

The whole or part of the example embodiments disclosed above can be described as, but not limited to, the following supplementary notes. Note, however, that the present invention is not limited to the techniques described in the supplementary notes below, but may be altered in various ways by a skilled person within the scope of the claims.

### Supplementary Note E1

A non-transitory recording medium having recorded thereon an information processing program for causing a computer to function as an information processing apparatus,
the information processing program causing the computer to carry out:
   a first acquiring process of acquiring information regarding a user;
   a second acquiring process of acquiring information regarding an item;
   a transforming process for performing a transformation to a vector on each of the information regarding the user and the information regarding the item, the one or more transforming means being trained with use of training data which includes data generated by a trained model; and
   the predicting process of predicting compatibility between the user and the item with reference to the vector obtained by the transforming process.

### REFERENCE SIGNS LIST

1, 2, 100, 200: Information processing apparatus
11, 21: First acquiring section (first acquiring means)
12, 22: Second acquiring section (second acquiring means)
13: Transforming section (transforming means)
14: Predicting section (predicting means)
23: Training section (training means)

1. An information processing apparatus, comprising
at least one processor, the at least one processor carrying out:
a first acquiring process of acquiring information regarding a user;
a second acquiring process of acquiring information regarding an item;
a transforming process that is carried out with use of one or more transforming means for performing a transformation to a vector on each of the information regarding the user and the information regarding the item, the one or more transforming means being trained with use of training data which includes data generated by a trained model; and
a predicting process of predicting compatibility between the user and the item with reference to the vector obtained through the transformation performed by the one or more transforming means.

2. The information processing apparatus according to claim 1, wherein
the item includes at least one selected from the group consisting of a product and a measure.

3. The information processing apparatus according to claim 2, wherein
the one or more transforming means are trained with use of a loss function in which respective weights different from each other are applied to:
a first loss value obtained with reference to the data generated by the trained model; and
a second loss value obtained with reference of data other than the data generated by the trained model.

4. An information processing apparatus, comprising
at least one processor, the at least one processor carrying out:
a first acquiring process of acquiring at least one piece of information selected from the group consisting of information regarding a user and information regarding an item;
a second acquiring process of acquiring, with reference to the at least one piece of information acquired by the first acquiring process, data generated by a trained model; and
a training process of training one or more transforming means with use of training data which includes the data acquired by the second acquiring process, the one or more transforming means being configured to perform a transformation to a vector on each of the user and the item.

5. The information processing apparatus according to claim 4, wherein
in the second acquiring process, the at least one processor:
generates one or more prompts with reference to the at least one piece of information acquired in the first acquiring process; and
acquires, as the data generated by the trained model, data outputted by the trained model which has inputted thereto the one or more prompts generated.

6. The information processing apparatus according to claim 5, wherein
the one or more prompts include
a query sentence for making, based on information from the user acquired by the first acquiring means, a query about the information regarding the item.

7. An information processing method, comprising:
at least one processor acquiring information regarding a user;
the at least one processor acquiring information regarding an item;
the at least one processor performing a transformation to a vector on each of the information regarding the user and the information regarding the item via one or more transforming means, the one or more transforming means being trained with use of training data which includes data generated by a trained model; and
the at least one processor predicting compatibility between the user and the item with reference to the vector obtained through the transformation.

8. A non-transitory recording medium storing a program for causing a computer to function as the information processing apparatus according to claim 1,
the program causing the computer to carry out:
the first acquiring process;
the second acquiring process;
the transforming process; and
the predicting process.

9. A non-transitory recording medium storing a program for causing a computer to function as the information processing apparatus according to claim 4,
the program causing the computer to carry out:
the first acquiring process;
the second acquiring process; and
the training process.
